(19) United States
(12) Patent Application Publication
(10) Pub. No.: US 2026/0072610 A1
(43) Pub. Date: Mar. 12, 2026

(54) CONTAINER-BASED READ/WRITE CONTROL METHOD, APPARATUS, AND DEVICE

(71) Applicant: Beijing Volcano Engine Technology Co., Ltd., Beijing (CN)

(72) Inventor: Jizhuang ZHAO, Beijing (CN)

(21) Appl. No.: 19/266,025

(22) Filed: Jul. 10, 2025

(30) Foreign Application Priority Data
Sep. 6, 2024 (CN) 202411252984.2

(51) Int. Cl. G06F 3/06

(52) U.S. Cl. CPC G06F 3/0655; G06F 3/0604; G06F 3/0679

(57) ABSTRACT

The present application discloses a container-based read/write control method and apparatus, and a device, which are used to solve a technical problem of data loss after a container is restarted in a container root file system. The method includes: creating an original container root file system according to a container image in response to a start of a container, where the original container root file system includes an original image read-only layer and an original container read-write layer; creating a local directory on a host; and using the original container root file system as an image read-only layer of a container root file system, using the local directory as a container read-write layer of the container root file system, and generating the container root file system.

### CROSS-REFERENCE TO RELATED APPLICATION(S)

The present application claims priority to Chinese Patent Application No. 202411252984.2, filed with the China National Intellectual Property Administration on Sep. 6, 2024 and entitled “container-based read/write control method, apparatus, and device”, which is incorporated herein by reference in its entirety.

### FIELD

The present application relates to the field of computer technologies and, in particular, to a container-based read/write control method and apparatus, and a device.

### BACKGROUND

Container technology, also referred to as container virtualization, is a lightweight virtualization technology. A container needs to use a root file system (rootfs) when running on a host. At present, the root file system of a container is created according to a container image. The root file system of a container consists of two parts: an image read-only layer and a container read-write layer.

### SUMMARY

An embodiment of the present application provides a container-based read/write control method and apparatus, and a device.

The technical solutions provided in the embodiments of the present application are as follows:

In a first aspect, an embodiment of the present application provides a container-based read/write control method, where the method includes:
creating an original container root file system according to a container image in response to a start of a container, where the original container root file system includes an original image read-only layer and an original container read-write layer;
creating a local directory on a host; and
using the original container root file system as a read-only layer of a container root file system, using the local directory as a read-write layer of the container root file system, and generating the container root file system.

In a second aspect, an embodiment of the present application provides a container-based read/write control apparatus, where the apparatus includes:
a first creation unit, configured to create an original container root file system according to a container image in response to a start of a container, where the original container root file system includes an original image read-only layer and an original container read-write layer;
a second creation unit, configured to create a local directory on a host; and
a generation unit, configured to use the original container root file system as a read-only layer of a container root file system, use the local directory as a read-write layer of the container root file system, and generate the container root file system.

In a third aspect, an embodiment of the present application provides a container-based read/write control device, including: a memory, a processor, and a computer program stored in the memory and executable on the processor, where the computer program, when executed by the processor, implements the container-based read/write control method as described above.

In a fourth aspect, an embodiment of the present application provides a computer-readable storage medium having instructions stored thereon, where the instructions, when executed on a terminal device, cause the terminal device to implement the container-based read/write control method as described above.

### BRIEF DESCRIPTION OF THE DRAWINGS

FIG. 1 is a schematic diagram of an exemplary application scenario according to an embodiment of the present application.

FIG. 2 is a flowchart of a container-based read/write control method according to an embodiment of the present application.

FIG. 3 is a schematic diagram of establishing a root file system of a container according to an embodiment of the present application.

FIG. 4 is a schematic diagram of establishing an original container root file system according to an embodiment of the present application.

FIG. 5 is a schematic diagram of a container-based read/write control apparatus provided by an embodiment of the present application.

FIG. 6 is a schematic diagram of an electronic device provided by an embodiment of the present application.

### DETAILED DESCRIPTION OF EMBODIMENTS

Currently, since a container is usually designed to be stateless, when the container is restarted, the root file system will be recreated based on the container image, and the data written by the container in the container read-write layer will be lost. However, if the data in the read-write layer of the root file system is lost, it may affect the normal operation of the application using the container. Therefore, how to achieve that the data written into the container root file system is not lost after the container is restarted is a technical problem that needs to be solved.

In order to make the aforementioned objects, features and advantages of the embodiments of the present application more comprehensible, the embodiments of the present application will be described in further detail below with reference to the drawings and specific implementations.

In order to facilitate understanding and explanation of the technical solutions provided in the embodiments of the present application, the background art of the embodiments of the present application will be described below.

The root file system required for the container to run is created from the container image, and the container root file system consists of two parts: an image read-only layer and a container read-write layer. At present, since a container is usually designed to be stateless, when the container is restarted, the root file system will be recreated based on the container image, and the data written by the container in the container read-write layer will be lost. However, if the data in the read-write layer is lost, it may affect the normal operation of the application using the container. For example, for some rich container applications, this type of application is containerized from a traditional application, but is not completely containerized, and the container is often used in the same way as a virtual machine. Some temporary files will be read and written under the read-write layer of the root file system, and multiple processes will be managed based on the written data. Therefore, if the data in the root file system is lost after the container is restarted, the normal operation of this type of application will be affected.

Based on this, the embodiments of the present application provide a container-based read/write control method and apparatus, and a device. The read-write layer of the container root file system is separated from the image read-only layer. The image read-only layer is provided by an original container root file system obtained by decompressing the container image, and the container read-write layer is implemented by means of a separate local directory on the host. The container read-write layer and the image read-only layer are jointly mounted through overlay to generate the container root file system. The container read-write layer is implemented by means of the local directory on the host, and the data written into the container read-write layer will not be lost, thereby supporting the data persistence capability of the container read-write layer.

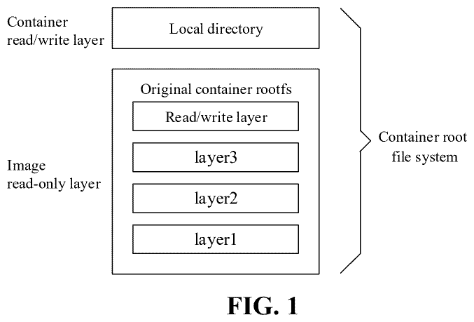

In order to facilitate understanding of the container-based read/write control method provided in the embodiments of the present application, the method will be described below with reference to an example scenario shown in FIG. 1. Referring to FIG. 1, which is a schematic diagram of an exemplary application scenario provided by an embodiment of the present application.

The embodiments of the present application may be applied to a host that creates a container. In the host, when the container is started, an original container root file system is generated by a snapshotter component in containerd (a lightweight container management tool) according to a container image. The original container root file system includes an original image read-only layer and an original container read-write layer. The original image read-only layer may include multiple layers, for example, layer1, layer2, and layer3. The original container read-write layer is usually a single layer, for example, a read-write layer. A local directory is created on the host. The original container root file system is used as a read-only layer of the container root file system, and the local directory on the host is used as a read-write layer of the container root file system to generate the container root file system. The container writes data into the read-write layer of the container root file system when running, and the data is written into the local directory of the host. After the container is restarted, the local directory in the host is not affected, and the data in the read-write layer of the container root file system will not be lost.

Those skilled in the art can understand that the schematic diagram of the framework shown in FIG. 1 is only an example in which the implementations of the present application can be implemented. The scope of application of the implementations of the present application is not limited by any aspect of the framework.

In order to facilitate understanding of the embodiments of the present application, a container-based read/write control method provided by an embodiment of the present application will be described below with reference to the drawings.

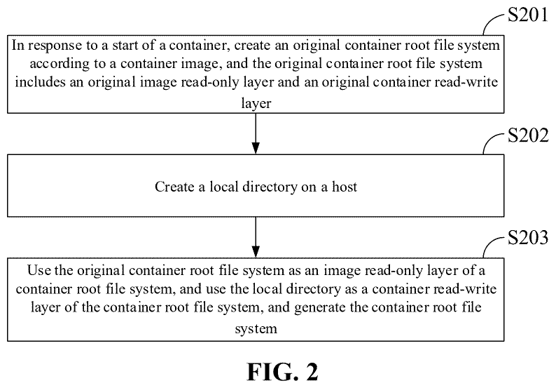

Referring to FIG. 2, which is a flowchart of a container-based read/write control method according to an embodiment of the present application, and as shown in FIG. 2, the method may include S201-S203.

S201: An original container root file system according to a container image is created in response to a start of a container, where the original container root file system includes an original image read-only layer and an original container read-write layer.

When a container is started, a container root file system needs to be created. First, a container image may be downloaded from an image repository. The container image is decompressed layer by layer to obtain an original container root file system. The original container root file system is a container root file system created by using a conventional method. The original container root file system may include an original image read-only layer and an original container read-write layer, where the original image read-only layer may include one or more layers, and the original container read-write layer is usually one layer. For the specific implementation process of S201 of creating the original container root file system according to the container image, reference may be made to the subsequent embodiments, which will not be described here.

S202: A local directory on a host is created.

When the container root file system needs to be created, a local directory is created on the host, where the local directory corresponds to the to-be-created container.

Therefore, in a possible implementation, the specific implementation of S202 of creating the local directory on the host may include the following.

A local directory corresponding to the container is created on the host.

In practical applications, a name of the local directory created on the host may include a name of the container created on the host, so that the local directory corresponds to the container created on the host. For example, a local directory named /un/container/<pod name>-<container name> is created on the host. The container name is a name of the container, and the pod name is a name of a pod (box). One pod may encapsulate one or more containers, and these containers share network and storage resources of the pod. Then the local directory may correspond to the container created on the host.

It can be understood that the embodiments of the present application do not limit the execution sequence between S201 and S202. S201 may be executed first, and then S202 is executed. Alternatively, S202 may be executed first, and then S201 is executed. Alternatively, S201 and S202 are executed in parallel.

S203: The original container root file system is used as a read-only layer of the container root file system, the local directory is used as a read-write layer of the container root file system, and the container root file system is generated.

After the original container root file system and the local directory on the host are generated, the original container root file system is used as the read-only layer of the container root file system, and the local directory is used as the read-write layer of the container root file system to generate the container root file system. This is equivalent to adding a local directory as the container read-write layer on top of the original container root file system to ensure that the data in the container read-write layer is not lost. For the specific implementation process of S203 of generating the container root file system, reference may be made to the subsequent embodiments, which will not be described here.

In this way, in the embodiments of the present application, the original container root file system is created according to the container image when the container is started, and the local directory is created on the host. The original container root file system is used as the read-only layer of the container root file system, and the local directory is used as the read-write layer of the container root file system to generate the container root file system. Therefore, when the container is running, data is written into the read-write layer of the container root file system, and at this time, the data is written into the local directory of the host, so the read-write layer of the container root file system has data persistence capability. After the container is restarted, the local directory in the host is not affected, and the data in the read-write layer of the container root file system will not be lost.

After the container root file system is created, a process in the container can read data in the root file system, and can also write data into the root file system.

In a possible implementation, the container-based read/write control method provided in the embodiments of the present application may further include the following.

When a process in the container requests to write data, the written data is saved in the local directory.

When the process in the container needs to write data into the established root file system, the process writes the data into the read-write layer of the root file system. Since the read-write layer of the root file system is implemented by the local directory in the host, the written data is saved in the local directory of the host. The written data has persistence capability and will not be lost with the restart of the container.

In a possible implementation, the container-based read/write control method provided in the embodiments of the present application may further include the following.

When a process in the container requests to read data, the requested data is read from the local directory.

If the requested data does not exist in the local directory, the requested data is read from the read-only layer of the container root file system.

When the process in the container needs to read data from the established root file system, the process first reads from the read-write layer of the root file system, that is, reads data from the local directory. However, if the requested data does not exist in the container read-write layer, that is, the local directory, the process further reads the data from the read-only layer of the container root file system.

Through the container root file system established in the embodiments of the present application, data can be normally read and written, and the written data will not change with the change of the state of the container.

In a possible implementation, the container-based read/write control method provided in the embodiments of the present application may further include the following.

In response to a restart of the container, the original container root file system is recreated according to the container image, where the original container root file system includes the original image read-only layer and the original container read-write layer.

The original container root file system is used as the read-only layer of the container root file system, and the local directory is used as the read-write layer of the container root file system to generate the container root file system.

In the embodiments of the present application, after the container is restarted, steps S201 and S203 are re-executed, so that the content of the read-only layer of the container root file system is replaced again, while the content of the read-write layer of the container root file system is saved on the host and will not be lost. After the container is restarted, the image read-only layer and the container read-write layer are jointly mounted again through overlay to generate the container root file system, and the data in the container read-write layer will not be lost.

In a possible implementation, the specific implementation of S203 of using the original container root file system as the read-only layer of the container root file system, using the local directory as the read-write layer of the container root file system, and generating the container root file system may include the following.

The original container root file system is used as a lower directory, and the local directory is used as an upper directory. The lower directory and the upper directory are jointly mounted into a merge directory as the container root file system.

In practical applications, the original container root file system is used as a lower directory (Lower Dir), the local directory (Local Dir) in the host is used as an upper directory (Upper Dir), and the lower directory and the upper directory are jointly mounted into a merge directory (Merge Dir), so as to generate the root file system (Rootfs) of the container.

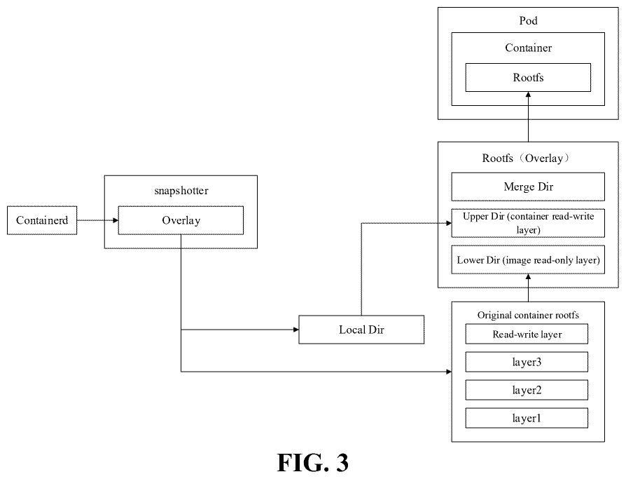

Referring to FIG. 3, which is a schematic diagram of establishing the container root file system according to an embodiment of the present application. The embodiments of the present application adopt the manner of separating reading from writing of the root file system Rootfs of the container. The snapshotter component of containerd only provides the image read-only layer, and the container read-write layer is provided by the local file system of the host.

In practical applications, an overlay snapshotter component in containerd is used to create an original container root file system (containerd rootfs). The original container root file system includes an original image read-only layer (for example, layer1, layer2, and layer3) and an original container read-write layer (for example, a read-write layer). The original container root file system is used as the read-only layer of the container root file system. The overlay snapshotter is a snapshotter component corresponding to an overlay hierarchical file system, and containerd supports the overlay snapshotter by default.

The overlay snapshotter creates a local directory (Local Dir) named /run/container/<pod name>-<container name> on the host when preparing the container root file system.

The original container root file system is used as a lower directory (Lower Dir), and the local directory is used as an upper directory (Upper Dir). An overlayfs is jointly mounted through overlay to obtain a merged directory (Merge Dir) as the final container root file system.

When a process in the container reads and writes data, the written content will be saved in the “Local Dir” directory.

When the container is restarted, the original container root file system is recreated, and the original container root file system and the local directory are jointly mounted through overlay to obtain the final container root file system. Since the local directory of /run/container/<pod name>-<container name> is persisted on the host, the restart of the container does not affect the content therein, that is, the persistence capability of the container read-write layer is achieved.

In a possible implementation, the specific implementation of S201 of creating the original container root file system according to the container image in response to the start of the container may include the following.
A1: In response to the start of the container, the read-only layer of the original image is generated by decompressing the container image layer by layer.
A2: The read-write layer of the original container is established based on the read-only layer of the original image.
A3: The read-only layer of the original image and the read-write layer of the original container are grouped into the original container root file system.

In the embodiments of the present application, when the container is started, after the container image is acquired, at least one original image read-only layer may be obtained by decompressing the container image layer by layer. Based on the original image read-only layer, one original container read-write layer may be further established, thereby generating the original container root file system.

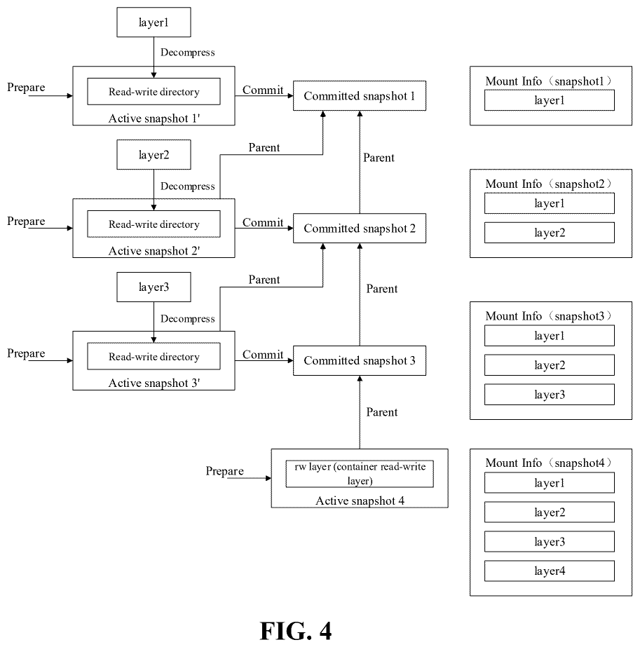

Referring to FIG. 4, which is a schematic diagram of creating the original container root file system. In the process of preparing the original container root file system by snapshotter, the more critical methods are the Prepare and Commit methods, which will be described below with specific examples.

Snapshotter prepares the directory layer by layer according to the container image. For example, the first layer is directly decompressed into a specified directory as the first snapshot. When preparing the second layer of the image, the second layer of the image is decompressed on the content of the file system of the first snapshot as the second snapshot. Similarly, when preparing the nth snapshot, the nth layer of the image is decompressed on the basis of the n−1th snapshot. When preparing the snapshot, an Active snapshot (active snapshot) which can be read and written is created by Prepare first. After the snapshot is mounted, the image is decompressed into the snapshot, and then the snapshot is submitted as a Committed snapshot (read-only snapshot). The container image consists of multiple read-only layers, and the rootfs of the container is implemented by the image read-only layer plus a container read-write layer. The implementation mechanism of snapshotter corresponds to the image layer one by one.

Specifically, in FIG. 4, the container image is a three-layer container image. When preparing the snapshots of the image, snapshotter first creates a snapshot 1′ in an Active state through Prepare, and the call returns the mount information of an empty directory (parent is “”), which is a readable and writable folder after being mounted.

The first layer of the image (layer1) is decompressed into the folder, and Commit is called to generate snapshot1 in a committed state. The parent snapshot of snapshot1 is empty. Then snapshot 1′ is removed. At this time, the mount information returned by calling the Mount, Prepare, and View operations on snapshot1 is mounted, and the content of the file system therein is the content of the decompressed image layer 1.

Through Prepare, snapshot 2′ in an Active state is created with snapshot1 as the parent snapshot. After snapshot 2′ is mounted, the content of the first layer of the image will be included in the directory. At this time, the second layer of the image (layer2) is decompressed into the directory where snapshot 2′ is mounted, and Commit is called again to generate snapshot2 in a committed state. At this time, the mount information returned by calling the Mount, Prepare, and View operations on snapshot2 is mounted, and the content of the file system therein is the content of the image layer 1 and the image layer 2 that are decompressed in turn.

Similarly, through Prepare, snapshot 3′ in an Active state is created with snapshot2 as the parent snapshot, and then the third layer of the image (layer3) is decompressed therein to finally generate snapshot3 in a committed state. snapshot1, snapshot2, and snapshot3 are all read-only and immutable. At this time, the mount information returned by calling the Mount, Prepare, and View operations on snapshot3 is mounted, and the content of the file system therein is the content of the image layer 1, the image layer 2, and the image layer 3 that are decompressed in turn, which is used as the image read-only layer.

When the container is started, a Prepare interface of snapshotter is called to create a snapshot4 in an Active state with snapshot3 as the parent snapshot. At this time, the mount information returned by the Prepare call is mounted, which is the original rootfs directory of the container. The content included in the original rootfs directory of the container is the content of the image layer1, layer2, and layer3 that are superimposed in turn. At the same time, since the snapshot is in the Active state, the directory is readable and writable and is used as the container read-write layer. Thus, the original container root file system is created.

Based on the container-based read/write control method provided in the above method embodiments, the embodiments of the present application further provide a container-based read/write control apparatus, which will be described below with reference to the drawings.

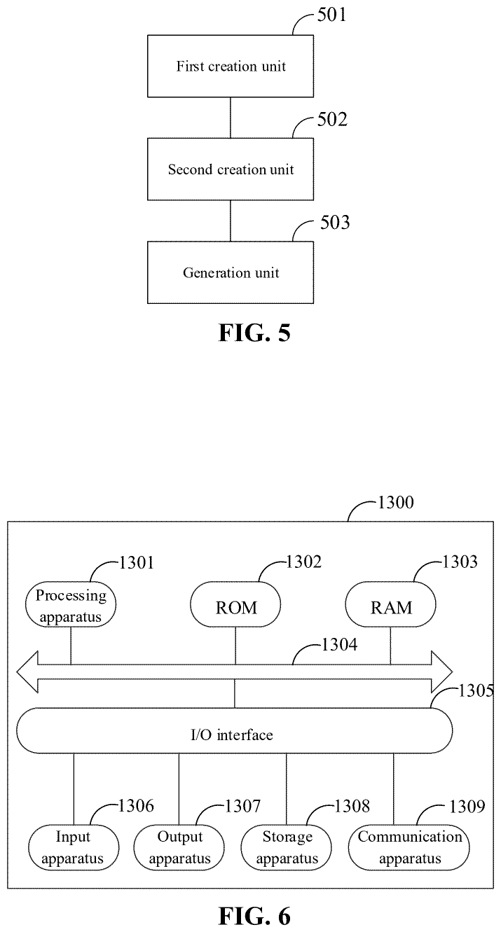

Referring to FIG. 5, which is a schematic structural diagram of a container-based read/write control apparatus provided by an embodiment of the present application. As shown in FIG. 5, the container-based read/write control apparatus includes:
a first creation unit 501, configured to create an original container root file system according to a container image in response to a start of a container, where the original container root file system includes an original image read-only layer and an original container read-write layer;
a second creation unit 502, configured to create a local directory on a host; and
a generation unit 503, configured to use the original container root file system as a read-only layer of a container root file system, use the local directory as a read-write layer of the container root file system, and generate the container root file system.

In a possible implementation, the apparatus further includes:
a triggering unit, configured to in response to a restart of the container, trigger the first creation unit to recreate the original container root file system according to the container image, where the original container root file system includes the original image read-only layer and the original container read-write layer; and trigger the generation unit to use the original container root file system as the read-only layer of the container root file system, use the local directory as the read-write layer of the container root file system, and generate the container root file system.

In a possible implementation, the generation unit is further configured to:
use the original container root file system as the lower directory, use the local directory as the upper directory, and jointly mount the lower directory and the upper directory into the merge directory as the container root file system.

In a possible implementation, the second creation unit is further configured to:
create the local directory corresponding to the container on the host.

In a possible implementation, the first creation unit is further configured to:
in response to the start of the container, generate the original image read-only layer by decompressing the container image layer by layer;
establish the original container read-write layer based on the original image read-only layer; and
group the original image read-only layer and the original container read-write layer into the original container root file system.

In a possible implementation, the apparatus further includes:
a writing unit, configured to after the container root file system is generated, when a process in the container requests to write data, save the written data in the local directory.

In a possible implementation, the apparatus further includes:
a reading unit, configured to after the container root file system is generated, when a process in the container requests to read data, read the requested data from the local directory; and if the requested data does not exist in the local directory, read the requested data from the read-only layer of the container root file system.

In the embodiments of the present application, the original container root file system is created according to the container image when the container is started, and the local directory is created on the host. The original container root file system is used as the read-only layer of the container root file system, and the local directory is used as the read-write layer of the container root file system to generate the container root file system. Therefore, when the container is running, data is written into the read-write layer of the container root file system, and at this time, the data is written into the local directory of the host, so the read-write layer of the container root file system has data persistence capability. After the container is restarted, the local directory in the host is not affected, and the data in the read-write layer of the container root file system will not be lost.

In addition, the embodiments of the present application further provide a computer program product, including computer program instructions. The computer program instructions, when executed on a computer, cause the computer to implement the container-based read/write control method as described above.

Based on the container-based read/write control method provided in the above method embodiments, the present application further provides an electronic device, including: one or more processors; and a storage apparatus having one or more programs stored thereon. The one or more programs, when executed by the one or more processors, cause the one or more processors to implement the container-based read/write control method as described above.

Reference is made to FIG. 6, which illustrates a schematic structural diagram of an electronic device 1300 suitable for implementing the embodiments of the present application. The terminal device in the embodiments of the present application may include, but is not limited to, a mobile terminal such as a mobile phone, a notebook computer, a digital broadcast receiver, a personal digital assistant (PDA), a tablet computer, a portable media player (PMP), a vehicle-mounted terminal (such as a vehicle-mounted navigation terminal), or the like, and a stationary terminal such as a digital television (TV), a desktop computer, or the like. The electronic device shown in FIG. 6 is only an example, and should not impose any limitation to the function and scope of use of the embodiments of the present application.

As shown in FIG. 6, the electronic device 1300 may include a processing apparatus (such as a central processing unit, a graphics processor, etc.) 1301, which may perform various suitable actions and processes according to a program stored in a read-only memory (ROM) 1302 or a program loaded from a storage apparatus 1306 into a random access memory (RAM) 1303. The RAM 1303 further stores various programs and data required for operations of the electronic device 1300. The processing apparatus 1301, the ROM 1302, and the RAM 1303 are connected to each other through a bus 1304. An input/output (I/O) interface 1305 is also connected to the bus 1304.

Generally, the following apparatuses may be connected to the I/O interface 1305: an input apparatus 1306, including, for example, a touchscreen, a touchpad, a keyboard, a mouse, a camera, a microphone, an accelerometer, a gyroscope, and the like; an output apparatus 1307, including, for example, a liquid crystal display (LCD), a speaker, a vibrator, and the like; a storage apparatus 1306, including, for example, a magnetic tape, a hard disk, and the like; and a communication apparatus 1309. The communication apparatus 1309 may allow the electronic device 1300 to perform wireless or wired communication with other devices to exchange data. Although FIG. 6 shows the electronic device 1300 having various apparatuses, it should be understood that not all of the illustrated apparatuses are necessarily implemented or provided. Alternatively, more or fewer apparatuses may be implemented or provided.

In particular, according to the embodiments of the present application, the processes described above with reference to the flowcharts may be implemented as a computer software program. For example, an embodiment of the present application includes a computer program product including a computer program carried on a non-transitory computer-readable medium. The computer program includes program codes for executing the methods shown in the flowcharts. In such an embodiment, the computer program may be downloaded from the network and installed through the communication apparatus 1309, or may be installed from the storage apparatus 1306, or may be installed from the ROM 1302. When the computer program is executed by the processing apparatus 1301, the above-mentioned functions defined in the methods of the embodiments of the present application are executed.

The electronic device provided in the embodiments of the present application belongs to the same inventive concept as the container-based read/write control method provided in the above embodiments. For the technical details not described in detail in this embodiment, reference may be made to the above embodiments, and this embodiment has the same beneficial effects as the above embodiments.

Based on the container-based read/write control method provided in the above method embodiments, an embodiment of the present application provides a computer-readable medium having a computer program stored thereon, where the program, when executed by a processor, implements the container-based read/write control method as described in any one of the above embodiments.

It should be noted that the computer-readable medium described in the embodiments of the present application may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the embodiments of the present application, the computer-readable storage medium may be any tangible medium that contains or stores a program. The program may be used by or in combination with an instruction execution system, apparatus, or device. In the embodiments of the present application, the computer-readable signal medium may include a data signal propagated in a baseband or as a part of a carrier wave, and computer-readable program codes are carried in the data signal. The data signal propagated in this manner may be in various forms, including, but not limited to, an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program codes contained in the computer-readable medium may be transmitted by any suitable medium, including, but not limited to, an electric wire, an optical cable, radio frequency (RF), or any suitable combination thereof.

In some implementations, the client and the server may communicate using any currently known or future-developed network protocol such as Hypertext transfer protocol (HTTP), and may be connected to any form or medium of digital data communication (for example, communication network). Examples of the communication network include a local area network (“LAN”), a wide area network (“WAN”), an internet (for example, the Internet), a peer-to-peer network (for example, an ad hoc peer-to-peer network), and any currently known or future-developed network.

The above-mentioned computer-readable medium may be included in the above-mentioned electronic device, or may exist alone without being assembled into the electronic device.

The above-mentioned computer-readable medium carries one or more programs, and when the above-mentioned one or more programs are executed by the electronic device, the electronic device is caused to execute the above-mentioned container-based read/write control method.

The computer program codes for performing the operations of the embodiments of the present application may be written in one or more programming languages or a combination thereof. The preceding programming languages include, but are not limited to, object-oriented programming languages such as Java, Smalltalk, and C++, and further include conventional procedural programming languages such as C or similar programming languages. The program codes may be executed entirely on a computer of a user, executed partly on the computer of the user, executed as a stand-alone software package, executed partly on the computer of the user and partly on a remote computer, or executed entirely on the remote computer or a server. In the case involving the remote computer, the remote computer may be connected to the computer of the user through any type of network, including a local area network (LAN) or a wide area network (WAN), or the connection may be made to an external computer (for example, through the Internet using an Internet service provider).

The flowcharts and block diagrams in the drawings illustrate possible architectures, functions, and operations of the system, method, and computer program product according to various embodiments of the present application. In this regard, each block in the flowcharts or block diagrams may represent a module, a program segment, or a portion of codes, and the module, the program segment, or the portion of codes contains one or more executable instructions for implementing specified logical functions. It is also to be noted that, in some alternative implementations, the functions marked in the blocks may also occur in a different order than the order marked in the drawings. For example, two successive blocks may, in fact, be executed substantially concurrently, or the two successive blocks may sometimes be executed in a reverse order, depending on the functions involved. It is also to be noted that each block in the block diagrams and/or flowcharts and a combination of blocks in the block diagrams and/or flowcharts may be implemented by a specific-purpose hardware-based system that performs specified functions or operations, or the each block in the block diagrams and/or flowcharts and the combination of blocks in the block diagrams and/or flowcharts may be implemented by a combination of specific-purpose hardware and computer instructions.

The units involved in the embodiments described in the present application may be implemented in software or hardware. A name of a unit/module does not constitute a limitation on the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the embodiments of the present application, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

It should be noted that the embodiments in the present specification are described in a progressive manner, and each embodiment focuses on differences from other embodiments, and the same or similar parts between the embodiments may be referred to each other. For the system or apparatus disclosed in the embodiments, since it corresponds to the method disclosed in the embodiments, the description thereof is relatively simple, and reference may be made to the description of the method part for relevant parts.

It should be understood that in the present application, “at least one” refers to one or more, and “a plurality” refers to two or more. “And/or” is used to describe an association relationship between associated objects, and represents that there may be three relationships, for example, “A and/or B” may represent: only A exists, only B exists, and both A and B exist simultaneously, where A and B may be singular or plural. The character “/” generally indicates that the preceding and following associated objects are in an “or” relationship. “At least one of the following” or similar expressions refer to any combination of these items, including any combination of a single item (one) or a plurality of items (ones). For example, at least one of a, b, or c may represent: a, b, c, “a and b”, “a and c”, “b and c”, or “a and b and c”, where a, b, and c may be single or plural.

It should also be noted that, in this text, relational terms such as first and second are only used to distinguish one entity or operation from another entity or operation, and do not necessarily require or imply any such actual relationship or order between these entities or operations. Moreover, the term “include/comprise” or any other variation thereof is intended to cover a non-exclusive inclusion, such that a process, method, article or device that includes a list of elements not only includes those elements but also includes other elements not expressly listed or elements inherent to such process, method, article or device. Without further limitations, an element defined by the phrase “include/comprise one” does not exclude the presence of additional identical elements in the process, method, article or device that includes the element.

The steps of the methods or algorithms described in connection with the embodiments disclosed herein may be implemented directly in hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable magnetic disk, a CD-ROM, or any other form of storage medium known in the art.

The above description of the disclosed embodiments enables those skilled in the art to implement or use the present application. Various modifications to these embodiments will be readily apparent to those skilled in the art, and the general principles defined herein may be implemented in other embodiments without departing from the spirit or scope of the present application. Therefore, the present application is not limited to these embodiments shown herein, but is to be accorded the widest scope consistent with the principles and novel features disclosed herein.

I/We claim:

1. A container-based read/write control method, comprising:
in response to a start of a container, creating an original container root file system according to a container image, the original container root file system comprising an original image read-only layer and an original container read-write layer;
creating a local directory on a host; and
generating, by using the original container root file system as an image read-only layer of a container root file system, and by using the local directory as a container read-write layer of the container root file system, the container root file system.

2. The method according to claim 1, wherein the method further comprises:
in response to a restart of the container, recreating the original container root file system according to the container image, the original container root file system comprising the original image read-only layer and the original container read-write layer; and
generating, by using the original container root file system as the image read-only layer of the container root file system, and by using the local directory as the container read-write layer of the container root file system, the container root file system.

3. The method according to claim 1, wherein generating, by using the original container root file system as the image read-only layer of the container root file system, and by using the local directory as a container read-write layer of the container root file system, the container root file system comprises:
using the original container root file system as a lower directory, using the local directory as an upper directory, and jointly mounting the lower directory and the upper directory into a merge directory as the container root file system.

4. The method according to claim 1, wherein creating the local directory on the host comprises:
creating the local directory corresponding to the container on the host.

5. The method according to claim 1, wherein in response to the start of the container, creating the original container root file system according to the container image comprises:
in response to the start of the container, generating the original image read-only layer by decompressing the container image layer by layer;
establishing the original container read-write layer based on the original image read-only layer; and
grouping the original image read-only layer and the original container read-write layer into the original container root file system.

6. The method according to claim 1, the method further comprising:
saving, after the container root file system being generated, and in response to a process in the container requesting to write data, the written data in the local directory.

7. The method according to claim 1, the method further comprising:
reading after the container root file system being generated, and in response to a process in the container requesting to read data, the requested data from the local directory; and
in response to that the requested data does not exist in the local directory, reading the requested data from the image read-only layer of the container root file system.

8. An electronic device, comprising:
one or more processors;
a storage device for storing one or more programs, wherein,
the one or more programs, when executed by the one or more processors, cause the one or more processors to:
in response to a start of a container, create an original container root file system according to a container image, the original container root file system comprising an original image read-only layer and an original container read-write layer;
create a local directory on a host; and
generate, by using the original container root file system as a read-only layer of an image of a container root file system, and by using the local directory as a container read-write layer of the container root file system, the container root file system.

9. The device according to claim 8, wherein the one or more programs further cause the one or more processors to:
in response to a restart of the container, recreate the original container root file system according to the container image, the original container root file system comprising the original image read-only layer and the original container read-write layer; and
generate, by using the original container root file system as the image read-only layer of the container root file system, and by using the local directory as the container read-write layer of the container root file system, the container root file system.

10. The device according to claim 8, wherein the one or more programs causing the one or more processors to generate, by using the original container root file system as the image read-only layer of the container root file system, and by using the local directory as a container read-write layer of the container root file system, the container root file system comprise instructions to:
use the original container root file system as a lower directory, use the local directory as an upper directory, and jointly mounting the lower directory and the upper directory into a merge directory as the container root file system.

11. The device according to claim 8, wherein the one or more programs causing the one or more processors to create the local directory on the host comprise instructions to:
create the local directory corresponding to the container on the host.

12. The device according to claim 8, wherein the one or more programs causing the one or more processors to in response to the start of the container, create the original container root file system according to the container image comprise instructions to:
in response to the start of the container, generate the original image read-only layer by decompressing the container image layer by layer;
establish the original container read-write layer based on the original image read-only layer; and
group the original image read-only layer and the original container read-write layer into the original container root file system.

13. The device according to claim 8, wherein the one or more programs further cause the one or more processors to:
save, after the container root file system being generated, and in response to a process in the container requesting to write data, the written data in the local directory.

14. The device according to claim 8, wherein the one or more programs further cause the one or more processors to:
read after the container root file system being generated, and in response to a process in the container requesting to read data, the requested data from the local directory; and
in response to that the requested data does not exist in the local directory, read the requested data from the image read-only layer of the container root file system.

15. A non-transitory storage medium containing computer-executable instructions, wherein the computer-executable instructions, when executed by one or more computer processors, are used to cause the one or more computer processors to:
in response to a start of a container, create an original container root file system according to a container image, the original container root file system comprising an original image read-only layer and an original container read-write layer;
create a local directory on a host; and
generate, by using the original container root file system as a read-only layer of an image of a container root file system, and by using the local directory as a container read-write layer of the container root file system, the container root file system.

16. The non-transitory storage medium according to claim 15, wherein the computer-executable instructions further cause the one or more processors to:
in response to a restart of the container, recreate the original container root file system according to the container image, the original container root file system comprising the original image read-only layer and the original container read-write layer; and
generate, by using the original container root file system as the image read-only layer of the container root file system, and by using the local directory as the container read-write layer of the container root file system, the container root file system.

17. The non-transitory storage medium according to claim 15, wherein the computer-executable instructions causing the one or more processors to generate, by using the original container root file system as the image read-only layer of the container root file system, and by using the local directory as a container read-write layer of the container root file system, the container root file system comprise instructions to:
use the original container root file system as a lower directory, use the local directory as an upper directory, and jointly mounting the lower directory and the upper directory into a merge directory as the container root file system.

18. The non-transitory storage medium according to claim 15, wherein the computer-executable instructions causing the one or more processors to create the local directory on the host comprise instructions to:
create the local directory corresponding to the container on the host.

19. The non-transitory storage medium according to claim 15, wherein the computer-executable instructions causing the one or more processors to in response to the start of the container, create the original container root file system according to the container image comprise instructions to:
in response to the start of the container, generate the original image read-only layer by decompressing the container image layer by layer;
establish the original container read-write layer based on the original image read-only layer; and
group the original image read-only layer and the original container read-write layer into the original container root file system.

20. The non-transitory storage medium according to claim 15, wherein the computer-executable instructions further cause the one or more processors to:
save, after the container root file system being generated, and in response to a process in the container requesting to write data, the written data in the local directory.
